(19) United States
(12) Patent Application Publication
(10) Pub. No.: US 2022/0335558 A1
(43) Pub. Date: Oct. 20, 2022

(54) SEGMENTED RELAY TRANSPORTATION NETWORK

(71) Applicant: Locomation, Inc., Pittsburgh, PA (US)

(72) Inventors: Thomas R. Kroswek, Novi, MI (US); Cetin Alp Meriçli, Pittsburgh, PA (US); Venkataramanan Rajagopalan, Sewickley, PA (US); Tekin Alp Meriçli, Pittsburgh, PA (US)

(21) Appl. No.: 17/719,479

(22) Filed: Apr. 13, 2022

Related U.S. Application Data
(60) Provisional application No. 63/174,569, filed on Apr. 14, 2021.
(60) Provisional application No. 63/225,112, filed on Jul. 23, 2021.
(60) Provisional application No. 63/305,718, filed on Feb. 2, 2022.

(51) Int. Cl. G06Q 50/30; G01C 21/34; B60W 60/00; G06Q 10/06

(52) U.S. Cl. CPC G06Q 50/30; G01C 21/343; B60W 60/005; G06Q 10/06311; G08G 1/22

(57) ABSTRACT

Methods and systems for optimizing allocation of personnel and equipment to on-highway freight movement. A network of segments and nodes are defined with relation to an existing highway system. Resources as units of work are then allocated and directed to use the network in particular ways. Improvements in equipment utilization, personnel utilization, transit time and driver at-home time are realized.

### CROSS REFERENCE TO RELATED APPLICATIONS

This patent application claims priority to a co-pending U.S. Provisional Application Ser. No. 63/174,569 filed Apr. 14, 2021 entitled “SEGMENTED RELAY TRANSPORTATION NETWORK”, and U.S. Provisional Application Ser. No. 63/225,112 filed Jul. 23, 2021 entitled “SEGMENTED RELAY TRANSPORTATION NETWORK”, and U.S. Provisional Application Ser. No. 63/305,718 filed Feb. 2, 2022 entitled “FREIGHT OPTIMIZATION”, the entire contents of each of which are hereby incorporated by reference.

### TECHNICAL FIELD

This patent application relates to arranging the components of a transportation network such as may be used to move freight over long distances using commercial vehicles.

### BACKGROUND

The three major trucking modes in use at this time are Parcel, Less Than Truckload (LTL), and Truckload (TL). Among TL carriers, those that operate as over the road (OTR) carriers make point to point moves with the driver domiciles used as origin and destination points before and after the moving of freight. OTR operations are inefficient in numerous ways including a) roughly 60% driver utilization b) 34% tractor utilization c) drivers often spend significant time away from home and d) freight transit time can be roughly twice what it would otherwise be if driver rest and sleeping time did not imply that the load stopped moving toward its destination.

### SUMMARY OF PREFERRED EMBODIMENTS

We describe methods and systems for configuring and managing a transportation network that divides a highway system into well-defined segments that are suited for optimal utilization of commercial equipment and drivers. Such optimal utilization is achieved by imposing an appropriate structure on the network, in terms of the highway segments utilized and the location of relay nodes, and by assigning freight and carriers to those segments in a particular way such that various anticipated changes in tractors, trailers, and the on-duty status of drivers occurs, ideally, only at the relay nodes. A network structured according to these principles will be denoted herein as a Segmented Relay Transportation Network (SRTN).

In one aspect, the SRTN may include multiple nodes, with the nodes including end nodes that serve as locations where a trailer and/or a tractor may enter or leave the network and relay nodes that serve as locations where a configuration change may occur. Legs specifying a unique path between two nodes with no nodes in between the legs optionally constrained to conform to a highway system the legs further organized such that sequences of legs, known as routes, form full segments that define a route of a length that depends on a maximum daily drive duration in distance or time between two nodes. Fractional segments define a route having a length that is an integer fraction of a full segment, segments that define a route whose length is an integer multiple of a full segment, or an integer multiple of a fractional segment. In addition, local segments define a route between an end node and a relay node.

In another embodiment, the SRTN includes multiple nodes, with end nodes that serve as locations where a trailer and/or a tractor may enter or leave the network and relay nodes that serve as locations were a configuration change may occur. Legs are defined such that each leg specifies a unique path between two nodes with no nodes in between the legs constrained to conform to a highway system. The legs are further organized such that sequences of legs, known as routes, form “full” segments that define a route of a length that depends on a designated drive duration in distance or time between two nodes. Fractional segments define a route having a length that is an integer fraction of a full segment; other segments may define a route whose length is an integer multiple of a full segment, or an integer multiple of a fractional segment. A convoy configuration is also defined as an assignment of a) tractors to trailers and/or b) drivers to tractors and/or c) a designation of which drivers are in service and/or d) assignment of loads to tractors; and assignments of drivers to a selected convoy configuration with two drivers assigned to a unit. A drive duration is then scheduled that comprises two or more fractional segments such that during a first fractional segment a first driver is in service while a second driver rests; and during a second fractional segment the first driver rests while the second driver is in service.

### BRIEF DESCRIPTION OF THE DRAWINGS

Additional novel features and advantages of the approaches discussed herein are evident from the text that follows and the accompanying drawings, where:

FIG. 1 depicts SRTN segments identified on an example portion of the US interstate highway system.

FIG. 2 is a chart comparing different use cases.

FIGS. 3A and 3B depict typical current usage of the US interstate highway system by an OTR carrier.

FIG. 4 depicts how a load with an origin and destination of greater than 500 or 1000 miles may be coordinated with the SRTN.

FIG. 5 illustrates an example system for assigning drivers, freight, tractors, trailers, routes, and legs according to the SRTN.

FIG. 6 is an example of data entity relationships.

### DETAILED DESCRIPTION OF ILLUSTRATIVE EMBODIMENT(S)

The effective movement of freight by trucks over a national or international network of highways presents a complex optimization problem subject to a large number of constraints generated by the highway system itself, the equipment used, human driver biological constraints, and regulations.

Over-The-Road Trucking

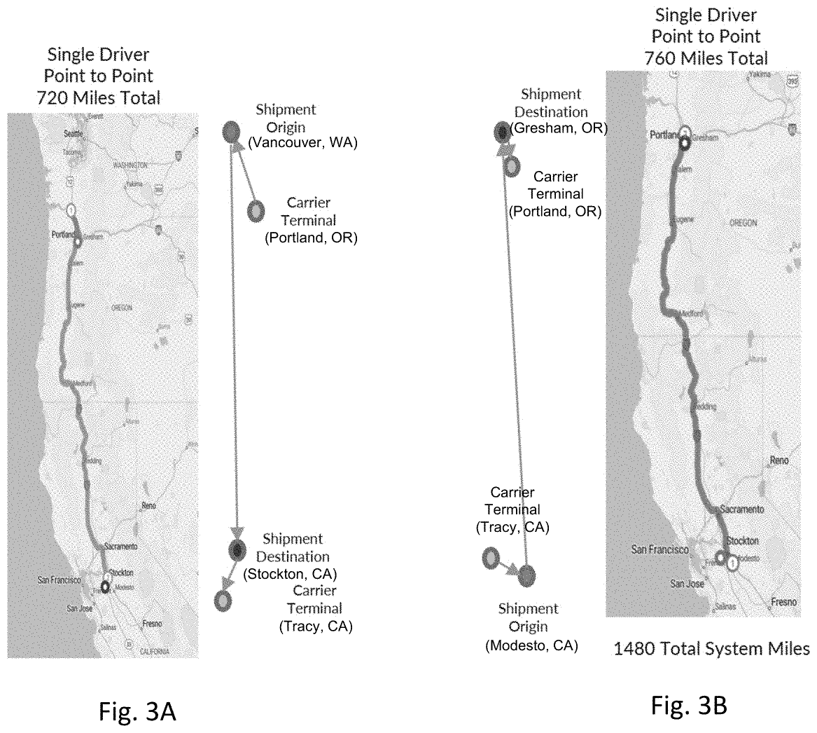

As shown in FIG. 3A, a frequently utilized mode of operations known as over-the-road (OTR) trucking refers to a procedure where a truck driver (or more than one truck driver) travels from a domicile (or carrier terminal) to a freight (shipment) origin, picks up the freight (perhaps by hooking up his tractor to a trailer), travels from the origin to a major highway, drives a significant distance of up to several thousand miles on the highway and then completes the process by leaving the highway to eventually drop the freight at its destination, and perhaps rest in a hotel or the truck at a carrier terminal. The driver(s) then may secure a second shipment (perhaps after a layover of a day or longer) that may originate somewhere near where they ended the first job, and then return to a second destination near their domicile as depicted in FIG. 3B.

Truck drivers are furthermore subject to Hours of Service (HOS) regulations that limit how long they may drive without a rest break and how long they can drive before a sleep break. OTR trucking involves a commitment of a single tractor and driver to an entire one-way trip. In the example shown in FIG. 3A, the freight has moved along the west coast of the US from the Portland Oreg. area to the Stockton, Calif. area, a one-way distance of more than 625 miles (not counting pick up and drop off). Jobs such as depicted in FIGS. 3A and 3B will therefore last at least several days. For this reason, OTR trucking is typically inefficient for the company that owns and operates the trucks (carriers), inefficient for the customers who own the freight (shippers), and it is difficult work for the truck drivers who are away from their domicile for days at a time.

Some of the inefficiencies and difficulties include:

roughly 50% utilization of equipment (trailers and trucks) because the equipment is idle when the driver is off-duty.

roughly 50% utilization of drivers because HOS regulations limit on-duty time to roughly half of a 24 hour period.

drivers may spend long periods away from their homes including periods called “layovers” spent sleeping, perhaps in the tractor itself.

shortages of truck parking for rest periods and drivers waiting for next loads.

Truck idling during rest periods which consumes an estimated 1 Billion gallons of diesel fuel at a cost of $3B and the carbon emissions associated with this idling of 60 thousand MMT (million metric tons).

Conventional operations take some steps to alleviate these issues including “team” driving where two drivers take turns driving while the other sleeps but not all jobs permit this approach either.

Trucking on a Segmented Relay Transportation Network (SRTN)

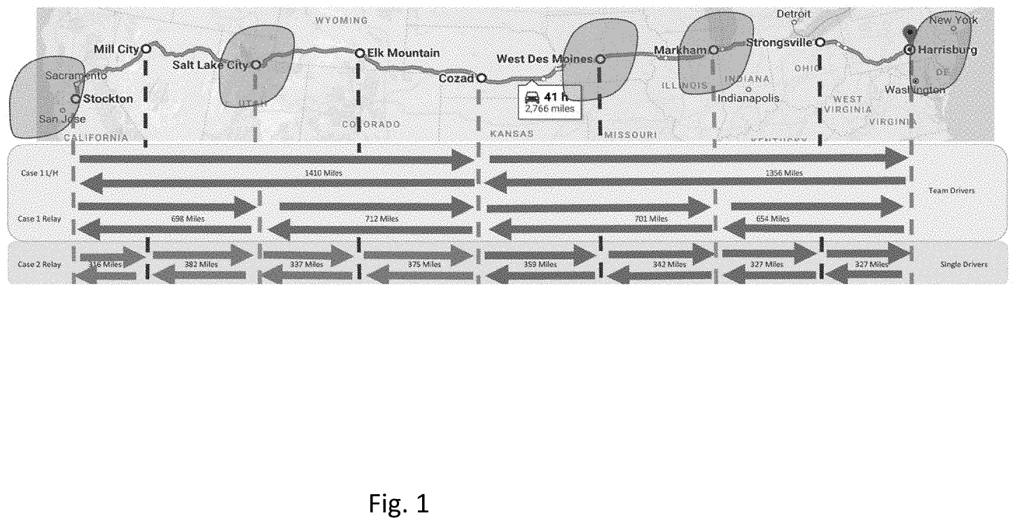

As shown in FIG. 1, an example embodiment defines a network, referred to herein as a Segmented Relay Transportation Network (SRTN), comprised of “legs” that initiate and terminate at nodes. Both the legs and the nodes may include locations that already exist on, along or adjacent a highway system. A sequence of connected legs may define a “route” that a vehicle may travel. Intermediate nodes on the route may form junctions at or near highway interchanges between two or more legs. In this example, the SRTN defines legs and nodes across the continental US along the I-80 and I-76 interstate highway system with nodes at Sacramento, Calif. and Harrisburg, Pa., and seven (7) other nodes located in Nevada, Utah, Wyoming, Nebraska, Iowa, Illinois and Ohio. In this example, the nodes are located approximately 300-350 miles apart.

A “driver”, as that term is used herein, includes either a human or autonomy logic. An off-duty driver may be located anywhere in a group of two or more vehicles traveling together. Therefore, when a first human is on-duty (“in service”) and driving one vehicle, an autonomy may be driving another vehicle, and a second driver may be off-duty, such that the off-duty driver may sleep in either the human-or the autonomy-driven vehicle.

As shown in FIG. 1, an important aspect is to arrange the legs and nodes of the SRTN such that it is possible to define or isolate routes between nodes known as “full segments”. Full segments are consistent with (i.e. close to without exceeding) the maximum distance and/or time that a single human driver may drive under prevailing regulations and driving conditions. In the US at this time, a full segment is roughly 500-700 miles, with its exact value varying depending on local speed limits, and average weather and traffic conditions.

It is also useful to design the SRTN such that it is possible to define or isolate numerous routes that are constrained, as much as possible, to be either fractions or multiples of a full segment as depicted in FIG. 1 and described in more detail below.

Team Driving Double Segments

For example a “double segment” can be defined for longer drives and driven, without stopping for significant periods in the middle, by a team of two drivers that alternately switch from on-duty to off-duty in a mode of operation known as “slip seating”. In this way the off-duty driver can get their mandated rest while the other driver keeps the truck moving. It should be understood that the resting driver may be sleeping or engaged in other activities while the other driver keeps the truck moving. In the example of FIG. 1, the arrows in the first two “Team Drivers” rows depict possible double segments.

More generally, a “segment” is any route whose length is an integer multiple of a full segment, or an integer multiple of a fractional segment as defined below. In other words, a segment has a length of (n/m) of a full segment where both n and m are integers and m may not be zero. In FIG. 1, the arrows in the second two “Team Drivers” rows depict examples of single segments.

Relays on Fractional Segments

If nodes are placed so as to define or isolate numerous routes that are integer fractions of a full segment, known as “fractional segments”, the network then supports efficient “relay operations”. Such nodes are known as “relay nodes”. For example, a single driver could drive a “half segment” in one direction, then swap loads or trailers, and return to the neighborhood of his domicile in a single day of duty. By extension:

two return trips of a “quarter segment” may be driven in one day of duty

a return trip of a full segment may be driven by team drivers

any closed route composed of 4 quarter segments may be driven in one day of duty

The “Single Drivers” rows in FIG. 1 depict example fractional segments.

More generally, any number of fractional segments may be concatenated into a “composite” route whose total length is a full segment; and some of those composite routes may return, either by traversing in the opposite direction or in a cycle, to the origin of the first load moved.

In these cases of relay operations, by definition, some change to the configuration of the tractor-trailer truck (the “unit”) should occur at a relay node. There can be no value in returning the original load to its origin, but there may be value in swapping drivers in the same unit (as in slip seating), swapping loads (trailers) only, or swapping the entire unit (meaning swapping drivers between units). By doing so, for example, two one-way trips of approximately 500-700 miles in length with two layovers, may become two two-way trips of 250-350 miles in length with all drivers returning home at the end of their duty and no layovers.

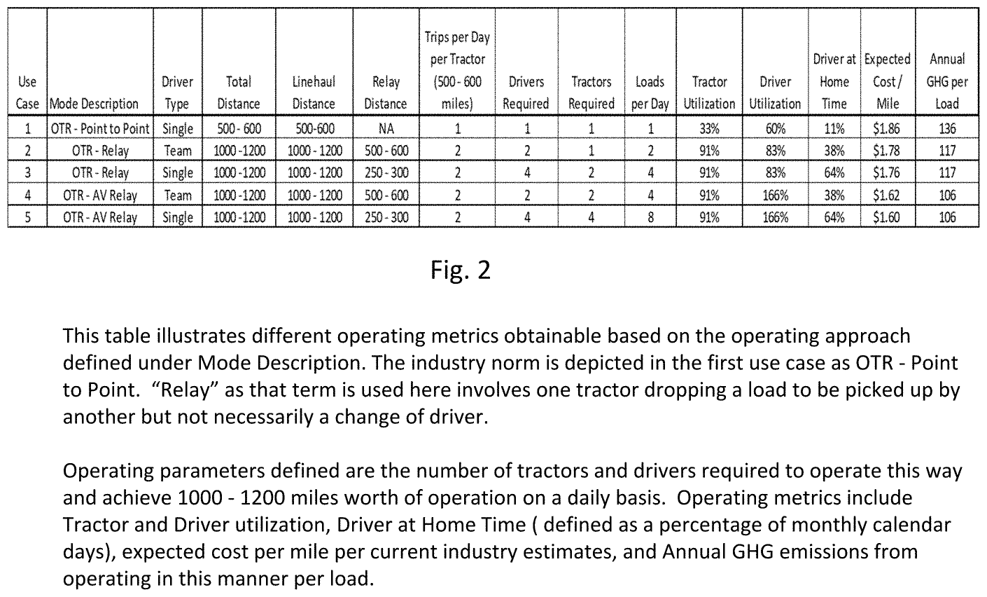

FIG. 2 is a table showing several example use cases and relative costs for moving freight a distance of between 1000 and 1200 miles. Case 1 is where a single driver moves a load 500-600 miles. Both tractor and driver utilization are low because the driver needs to rest before moving another load and the tractor is not moving at such times. In case 2, team drivers, two to a tractor, cooperate so that one drives while the other rests. The load is dropped halfway to its destination to be picked up by another team in another tractor, and the first team picks up a load bound for their home terminal, swaps drivers and returns home. In case 3, a single driver drops the load off at ¼ of the line haul distance, picks up another going in the other direction, and returns home before hours of service limits are exceeded. In case 4 team drivers are now operating a convoy of two units where one driver is in service at a time and where that driver is effectively directing two tractors because the second tractor is autonomous. As a result, driver utilization is doubled. Such AV (autonomous vehicle) cases are further discussed below. Case 5 illustrates how a single driver can operate a two unit convoy to move one load half the relay distance of case 4 and take a second load back to the driver's home terminal.

Other operating metrics are depicted, such as Tractor and Driver utilization, Driver at Home Time (as defined as a percentage of monthly calendar days), expected cost per mile using current industry estimates and Annual GHG emissions from operating in this manner per load.

Defining the SRTN to Optimally Support Relay Operations

In general, we may define a “configuration” of a tractor-trailer unit to be a time-varying association of a tractor, zero or more trailers, and one or more drivers per tractor, each of whom may be on-duty or off-duty at any moment. It is understood that an on-duty driver must be in the driver's seat of a tractor while off-duty drivers may be anywhere at such times when a change in their duty status is neither imminent nor recent. As a result a configuration change involving driver on-duty status possibly implies movement of drivers into or out of the driver's seat or both. To support relay operations well, the SRTN design should provide numerous, or as many as possible, opportunities to change the configuration of units at relay nodes.

More generally, nodes may be placed, based on the total freight volume on the highway system in a service area (such as a region spanned by all freight movements in the market being addressed), so as to maximize the capacity to decompose all freight movement into segments as defined above.

Configuration Changes Involving Autonomy

In a case where any unit is configured to permit autonomous driving, a driver may rapidly switch from on-duty to off-duty status while remaining in the driver's seat, and this option may be useful to override autonomy or to engage autonomy after a unit has been moved into an appropriate position or other state of motion. In this sense, autonomy is included in the definition of driver. In other words, the “driver” functions discussed herein may be performed either by a human person or by autonomy logic. Of course, any driver subject to Hours of Service regulations, or a need to rest or sleep, in the discussion will be a human driver.

Trucking with Convoys on the SRTN

Another example embodiment exploits the capacity of “split teams” to double equipment utilization or halve the transit time under certain conditions. It is well known that when trucks follow each other in a convoy. Fuel efficiency of both vehicles is therefore enhanced as each benefits from the presence of the other by reducing the wasted power necessary to merely move the air around the vehicles.

If we define a “convoy” to mean any number of units intending to move in formation, then we may, in such a case, redefine a (convoy) “configuration” to be the composite configuration of all participating units as well as a description of the relative positions and the roles of the units, and their status of present, or intended membership. Likewise, we may redefine a (convoy) “configuration change” as any change to the composite configuration of the convoy.

Examples peculiar to convoys may include swapping the role of leader with another vehicle, or the addition or deletion of a vehicle to or from a convoy. When convoys are involved, new relay operations may also be defined including the above convoy configuration changes. Such changes might be used, for example, to reconfigure two convoys arriving at a relay node at roughly the same time when the convoys have arrived or will depart (or both) on distinct legs. The edges connected at such nodes may have a Y topology or a “+” topology or more complicated or general topology.

In one example use of the SRTN, drivers may be assigned to a specific convoy configuration with two drivers assigned to a particular tractor-trailer unit. A schedule for a daily drive may then encompass three fractional segments such that:
a first driver drives during the first fractional segment while the second driver rests;
the second driver drives during the second fractional segment while the first driver rests; and
the first driver or second driver drives during the third fractional segment while the other driver rests.

It should be understood that a driver resting in a unit (e.g., an “off-duty” driver) may actually sleep during the convoy segments when they are assigned to rest while the other driver is active. This may assist with the driver complying with their hours of service rules.

As explained previously, a “driver”, as that term is used herein, includes either a human or autonomy. And as also mentioned previously, an off-duty driver may be anywhere in a convoy.

Therefore, when a first human is “in service” and driving one vehicle, an autonomy is driving another vehicle, and a second driver is off-duty, the off-duty driver may sleep in either the human-or the autonomy-driven tractor.

A duration (or length) of the first and second fractional segment may be approximately equal. The duration (or length) of the third fractional segment may be equal to the amount of driving hours remaining in a given day.

In another use of the SRTN, drivers may be assigned to convoy configurations so that they can return to a domicile at a specified time, such as at the end of each day, or after two days, or after four days, etc.

In one example use case, hours of service rules might allow for a total driving time of 11 hours before requiring a 10 hour rest. A single ½ hour break is also required at the 8 hour driving point, so theoretically a driver can drive 10.5 hours before requiring a switch with the other driver. Across a daily schedule this would equate to a first 11 hour segment with driver 1, then another 11 hour segment with driver 2 and then the cycle could start all over with driver 1. There would be two equal fractional segments (remaining out of a 24 hour day) and then a third which would be 2 hours which would be 18% of the other two. As this cycles throughout the week those 2 additional hours of driving rotate between the drivers.

Autonomous Convoys

Furthermore, during periods of time when at least one autonomous driving system is doing the driving of any unit, the convoy thereby becomes a (semi) autonomous or a (fully) autonomous convoy, both of which are referred to as autonomous convoys. Such an autonomous convoy could even include units which are entirely autonomous all of the time.

If we consider an example convoy composed of a human-driven leader and an autonomous follower, then the main benefit of such semi-autonomous operations is that a single human driver may be able to direct the motion of two or more vehicles on the SRTN and:

human driver utilization is thereby doubled because one driver may direct two or more units.

equipment utilization is doubled because drivers in different units may swap being on-duty (and perhaps the units swap positions and roles) to guide the convoy for periods of time.

transit times are improved because the convoy never needs to stop.

all of these benefits increase if there are more autonomous units in the convoy.

all of these benefits increase if the units are autonomous more of the time.

The aforementioned freedom for an off-duty driver to either be sleeping in a human-or the autonomy-driven tractor may require recognition that:

(a) when the two humans are traveling in the same tractor (in-service and off-duty), the convoy will eventually have to stop briefly to swap human drivers (which would be the case for a drone follower configuration); or

(b) when the two humans are not traveling in the same tractor, a human driver that would otherwise sleep in an autonomously operating follower could instead sleep in the human-driven leader (e.g., in a sleeper berth).

Optimal Transportation Management on the SRTN

While transportation management systems are known in industry today, the innovations presented herein lead to both new opportunities to optimize and new related issues to resolve when the SRTN is practiced.

The SRTN enables new optimization algorithms that exploit its benefits more fully than existing systems. In particular:

Nodes in the SRTN that is traversed by any two units at roughly the same time presents an opportunity to perform a configuration change.

A node that is traversed in opposite directions by any two trailers at roughly the same time presents an opportunity to convert two one way trips into two way trips.

Any one-way leg that is shared by any two units in a given time window presents an opportunity to combine both units in a convoy.

In more general terms, and in contrast to how transportation management is performed today for OTR trucking, a new optimization algorithm, the SRTN Transportation Management Algorithm (STMA) may operate as follows:

assemble a large number of freight orders that are to be executed in a period of time.

consider all or a large number of possible configurations of all assets (equipment and drivers) while respecting numerous constraints including HOS constraints.

in the utility function being optimized:

give highest weight to equipment utilization and transit time—keep the tractors moving

give somewhat lower weight to driver utilization—keep the driver on-duty as long a possible and use autonomous operations to reduce the number that are on-duty

give somewhat lower weight to driver at home time—get the drivers home as often and as long as possible

Other example implementations may vary the weighting of these considerations in arbitrary ways. The term “weight” above may be interpreted to mean an explicit numerical weighting in some function to be optimized. Weight could also be used as a synonym for “priority” if the optimization process treats each of the three considerations above as a hard constraint to be satisfied, if possible, even at the expense of lower priority constraints.

The problem of coordinating the movement of freight is a complex planning and scheduling problem where, among other things, any intended configuration changes require all participating “components” (drivers, tractors, trailers) to be in the same place at roughly the same time.

The task of moving a load in a trailer along a segment can be viewed as a “unit of work” in the STMA. For such a unit of work, at any point in the intended execution of the schedule, a trailer will have made some progress toward its destination in general, and it will have a “next” leg at that point. The next leg will have a start node and an end node.

In contrast to OTR trucking which assigns units to loads, the STMA can assign units of work to configurations whose components are planned to be in the vicinity of the start node of the next leg at close to the same time. The assignment may or may not prefer to simply continue the configuration used to reach the start node. In a case where there is a preference for a return trip for a driver, a configuration change may be performed to permit the driver to return. In a case where units in a convoy have different next legs, a configuration change will be needed for each unit to reach its destination.

In practice, this new management process is similar to treating the tractors on the same leg like continuously operating trains except that the train cars are removed from the train if they are empty. In this analogy, the optimization process is similar to attempting to make sure that the train cars are always full, because they will always be moving in that case.

Optimal Local Transportation Management on the SRTN

A further benefit of the SRTN is the fact that local trucking activity that moves loads between the SRTN nodes and origins, destinations, domiciles, carrier terminals etc. is deliberately removed from the SRTN in the sense that one end or the other of such “local legs” is not an SRTN node. This fact permits the management of local trucking activity to be largely decoupled from the more global activity on the SRTN.

Indeed, local activity can be accomplished with separate, older, lower capacity, lower speed, less automated, etc. equipment that is managed locally with the sole purpose of moving freight to and from the nearest (or nearest few) SRTN nodes with maximum efficiency. In this way the “end nodes” that connect to local legs operate as special relay nodes involving at least one local leg and at least one leg in the SRTN. Such activity may employ surface routes and legs are short enough that the drivers involved may work with more flexible schedules, and near their domiciles, at all times.

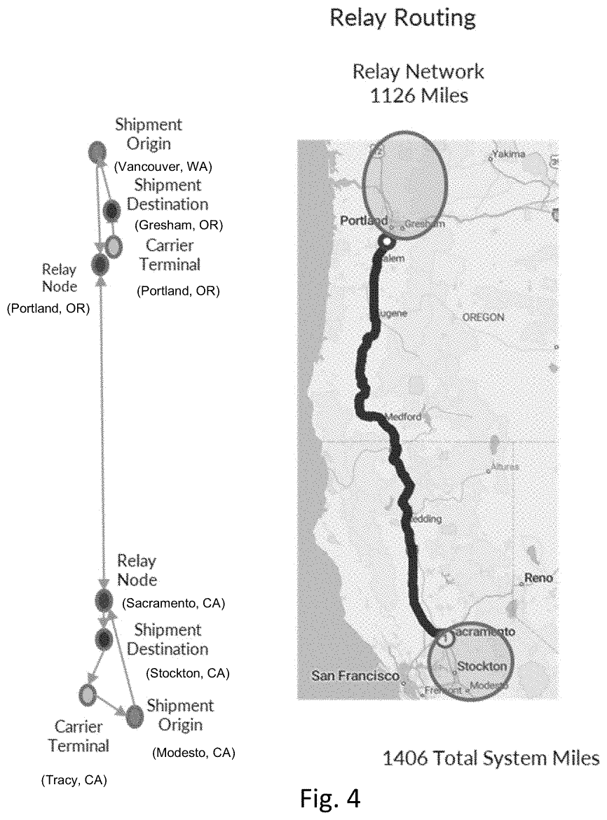

FIG. 4 represents one approach to handling a workload using the SRTN. This approach coordinates two (2) line hauls and four (4) local moves by breaking truckload moves into three components. Here a driver assigned to handle local activity is responsible for bringing the load to the carrier terminal in Portland, Oreg. and then either emptying the load or dropping and unhooking the trailer there. A different driver and truck assigned to linehaul tasks picks up the load (or hooks the trailer) and travels to the carrier terminal in Sacramento, Calif. Another driver assigned to local activity near Sacramento, Calif. then picks up the load and drops it at the destination in Stockton Calif.

The linehaul driver's activity is next coordinated with a another load and another task traveling in the opposite direction (say from Sacramento, Calif. to Portland Oreg.) with another driver responsible for moving the freight from the shipment origin in Modesto to the terminal in Sacramento, Calif., and yet another local driver responsible for moving the freight from the Portland, Oreg. carrier terminal to Gresham, Oreg.

Implementation Options

It should be understood that the SRTN, SRTA and corresponding support of relay operations and convoys is likely implemented using a number of computing devices and wireless communication devices. Applications software executing on these devices assists with defining the locations of nodes, legs, segments, and routes, as well as the configurations of tractor-trailer units, changes to unit configurations, coordinating schedules, and providing instructions and schedules to drivers and autonomous vehicles, etc.

As but one example, databases may store and provide access to information related to the current location and availability of resources such as tractors, trailers, drivers, freight to be moved, and the location of nodes, the paths that define legs, segments, and routes, and other information.

One or more servers may operate planning software to devise and assign schedules, relay locations, and routes for the tractors, trailers, drivers and their corresponding assignments to particular jobs. For example, multiple available relay nodes and possible routes and many possible combinations of available tractors, trailers, and drivers can be evaluated to devise a plan to move a particular piece of freight using the SRTN.

One or more servers and wired and wireless networks may then make the schedule and route available to other computers and devices. For example, most tractors in use today have onboard computers (OBC's) that can communicate directly with the driver and such systems. These OBCs can be programmed to communicate with the driver and provide updates as to the activity that is to take place within the SRTN. The same can also be accomplished via smartphone apps.

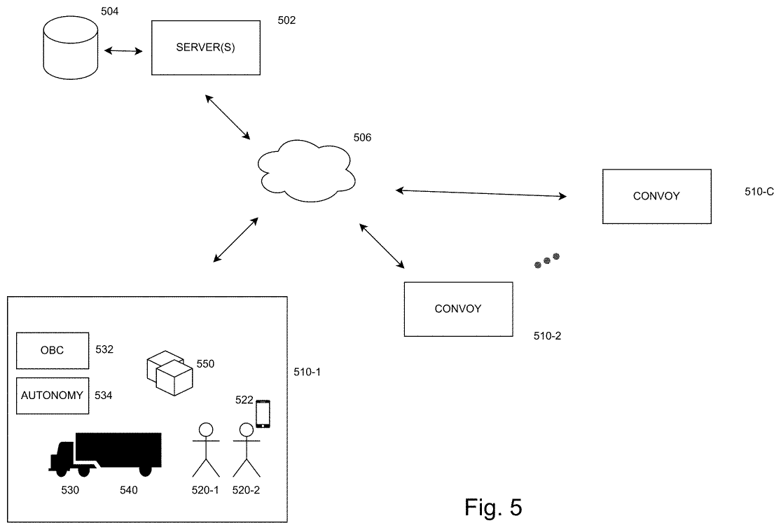

FIG. 5 depicts an example implementation. One or more servers 502 read and write data to a persistent store such as a relational database 504. The server(s) also access data processors associated with one or more convoys 510-1, 510-2, . . . 510-c over a wide area wireless network, which may include the Internet, cellular networks, satellite networks, private wireless networks and numerous other communication schemes. An example convoy 510-1 consists of, say two drivers 520-1, 520-2, a tractor 530, a trailer 540 and freight 550. An On Board Computer (OBC) 532 located on the tractor 530 communicates with the server(s) 502 over the wireless network 506 and displays SRTN information to the drivers 520 such as their assigned schedules to particular jobs, awake and sleep times, relay locations, pick up and drop off locations, and routes for their corresponding assignments. Alternatively, the drivers 520 may utilize a smartphone or tablet 522 to receive information and instructions regarding the SRTN. The tractor 530 also has autonomy logic 534 to implement full or partial self-driving capabilities.

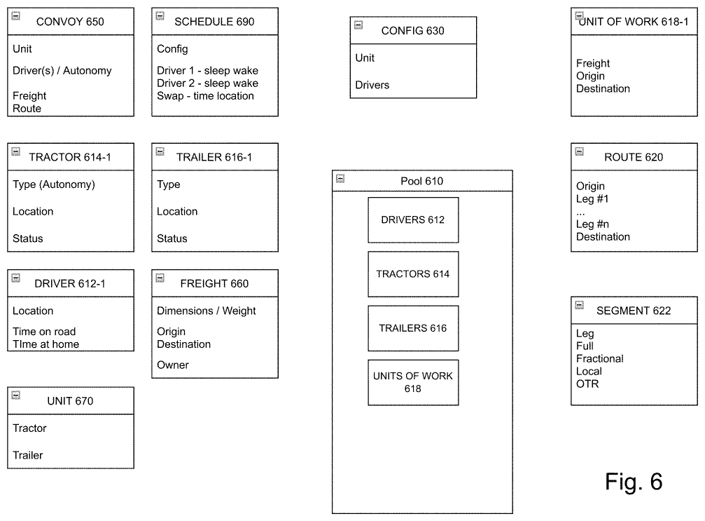

FIG. 6 is but one example of the types of relational data entities that may be maintained in the database 504. Numerous relationships between the data entities as depicted or other data entities not explicitly depicted but mentioned elsewhere herein may also be provided. For example, a driver entity 612-1 includes data about a particular driver, her location, current status (active idle), present and past schedule(s) such as time on the road, time resting, time at home, and the like. A tractor entity 614-1 may include information about its type (model number), whether or not it has autonomy logic, its location and status (active or idle). A trailer entity 616-1 may include information about its type, size, location and status (full load, partial load, or empty). A freight entity 660 describes a freight job, its size, origin, destination owner and other attributes. A unit entity 670 may associate a specific tractor 614 and trailer 616. A config entity may associate a particular unit 670 and team of driver(s) 612. A convoy entity 650 may associate a unit, drivers/autonomy logic, freight and a route. A unit of work entity 618-1 may associate specific freight 660 with an origin and destination. A route entity 620 may include an origin and destination and the legs (segments) that it comprises. A leg (segment) entity 622 may described whether it is full, double, fractional, or an OTR or local segment. A pool entity 610 may list available resources including drivers 612, tractors 614, trailers 616 available to service a particular unit of work 618. A schedule entity 690 may be the result of assigning a configuration, the awake and sleep times for assigned driver(s), and a time and location for the drivers to swap.

The foregoing description of example embodiments illustrates and describes systems and methods for implementing a transportation network. However, it is not intended to be exhaustive or limited to the precise form disclosed.

The embodiments described above may be implemented in many different ways. In some instances, the various “computers” and/or “controllers” are “data processors” or “embedded systems” that may be implemented by a one or more physical or virtual general purpose computers having a central processor, memory, disk or other mass storage, communication interface(s), input/output (I/O) device(s), and other peripherals. The general purpose computer is transformed into the processors with improved functionality, and executes the processes described above to provide improved operations. The processors may operate, for example, by loading software instructions, and then executing the instructions to carry out the functions described.

As is known in the art, such a computer may contain a system bus, where a bus is a set of hardware wired connections used for data transfer among the components of a computer or processing system. The bus or busses are shared conduit(s) that connect different elements of the computer system (e.g., processor, disk storage, memory, input/output ports, network ports, etc.) to enables the transfer of information. One or more central processor units are attached to the system bus and provide for the execution of computer instructions. Also attached to system bus are typically I/O device interfaces for connecting various input and output devices (e.g., sensors, lidars, cameras, keyboards, touch displays, speakers, wireless radios etc.) to the computer. Network interface(s) allow the computer to connect to various other devices or systems attached to a network. Memory provides volatile storage for computer software instructions and data used to implement an embodiment. Disk or other mass storage provides non-volatile storage for computer software instructions and data used to implement, for example, the various procedures described herein.

Certain portions may also be implemented as “logic” that performs one or more of the stated functions. This logic may include hardware, such as hardwired logic circuits, an application-specific integrated circuit, a field programmable gate array, a microprocessor, software, firmware, or a combination thereof. Some or all of the logic may be stored in one or more tangible non-transitory computer-readable storage media and may include computer-executable instructions that may be executed by a computer or data processing system. The computer-executable instructions may include instructions that implement one or more embodiments described herein. The tangible non-transitory computer-readable storage media may be volatile or non-volatile and may include, for example, flash memories, dynamic memories, removable disks, and non-removable disks.

Embodiments may therefore typically be implemented in hardware, firmware, software, or any combination thereof.

In some implementations, the computers or controllers that execute the processes described above may be deployed in whole or in part in a cloud computing arrangement that makes available one or more physical and/or virtual data processing machines via on-demand access to a network of shared configurable computing resources (e.g., networks, servers, storage, applications, and services) that can be rapidly provisioned and released with minimal management effort or service provider interaction.

Furthermore, firmware, software, routines, or instructions may be described herein as performing certain actions and/or functions. It also should be understood that the block and flow diagrams may include more or fewer elements, be arranged differently, or be represented differently. Therefore, it will be appreciated that such descriptions contained herein are merely for convenience and that such actions in fact result from computing devices, processors, controllers, or other devices executing the firmware, software, routines, instructions, etc.

While a series of steps has been described above with respect to the flow diagrams, the order of the steps may be modified in other implementations. In addition, the steps, operations, and steps may be performed by additional or other modules or entities, which may be combined or separated to form other modules or entities. For example, while a series of steps has been described with regard to certain figures, the order of the steps may be modified in other implementations consistent with the principles of the invention. Further, non-dependent steps may be performed in parallel. Further, disclosed implementations may not be limited to any specific combination of hardware.

No element, act, or instruction used herein should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The above description contains several example embodiments. It should be understood that while a particular feature may have been disclosed above with respect to only one of several embodiments, that particular feature may be combined with one or more other features of the other embodiments as may be desired and advantageous for any given or particular application. It is, of course, not possible to describe every conceivable combination of components or methodologies for purposes of describing the innovations herein, and one skill in the art may now, in light of the above description, recognize that many further combinations and permutations are possible. Also, to the extent that the terms “includes,” and “including” and variants thereof are used in either the detailed description or the claims, these terms are intended to be inclusive in a manner similar to the term “comprising”.

Accordingly, the subject matter covered by this patent is intended to embrace all such alterations, modifications, equivalents, and variations that fall within the spirit and scope of the claims that follow.

1. A transportation network comprising:
(i) a plurality of nodes, the nodes including end nodes that serve as locations where a trailer and/or a tractor may enter or leave the network; and
relay nodes that serve as locations were a configuration change may occur;
(ii) a plurality of legs, each leg specifying a unique path between two nodes with no nodes in between the legs optionally constrained to conform to a highway system the legs further organized such that sequences of legs, known as routes, form
full segments that define a route of a length that depends on a maximum daily distance or travel time between two nodes;
fractional segments that define a route having a length that is an integer fraction of a full segment;
segments that define a route whose length is an integer multiple of a full segment, or an integer multiple of a fractional segment; and
local segments that define a route between an end node and a relay node.

2. The network of claim 1 wherein:
(iii) at least some of the tractors and/or trailers are autonomous at least part of the time, and
(iv) a driver additionally comprises an autonomy system capable of driving at least one of the tractors.

3. The network of claim 1 wherein at least some of the tractors and/or trailers are organized as convoys and further wherein at least some convoys are autonomous and wherein at least one tractor is autonomous.

4. The network of claim 1 and further wherein
a convoy configuration is an assignment of a) tractors to trailers and/or b) drivers to tractors and/or c) a designation of which drivers are in service and/or d) assignment of loads to tractors; and
a convoy configuration change is a change in assignment of trailers, tractors and/or drivers in a convoy.

5. The network of claim 4 wherein drivers are assigned to a specific convoy configuration with a first and second driver assigned to a first and second unit, and further wherein:
a unit comprises a given tractor and an associated trailer;
a daily drive duration comprises three fractional segments such that
a first driver drives during the first fractional segment while a second driver rests;
the second driver drives during the second fractional segment while the first driver rests; and
the first or second driver drives during the third fractional segment while the other driver rests.

6. The network of claim 5 wherein a convoy configuration involves a given driver driving one of the units while the other driver rests, and another one of units is driven by autonomy logic.

7. The network of claim 5 wherein a time duration or length of the first and second fractional segment are approximately equal and the third fractional segment is the remainder in available time.

8. The network of claim 1 wherein components are assigned to configurations so that they can return to a domicile at the end of each day.

9. The network of claim 1 wherein components are assigned to configurations so that they can return to a domicile after a given number of days.

10. The network of claim 1 and further wherein:
work is allocated to drivers, tractors and trailers such that origin-destination pairs are divided into network activity and local activity, and whereby:
local activity relates to moving freight to and from one or more nearest nodes;
network activity relates to moving freight between nodes;
optimization of equipment utilization is given highest weight;
optimization of driver in service time is given second highest weight;
optimization of driver at-home time is given third highest weight; and/or
optimization of local activity is performed separately from network activity.

11. The network of claim 10 wherein a given leg is a shortest path in time, a path that consumes least fuel, a least cost path, or a path that meets some other criteria.

12. A transportation network comprising:
a plurality of nodes, the nodes including end nodes that serve as locations where a trailer and/or a tractor may enter or leave the network and relay nodes that serve as locations were a configuration change may occur;
a plurality of legs, each leg specifying a unique path between two nodes with no nodes in between the legs optionally constrained to conform to a highway system the legs further organized such that sequences of legs, known as routes, form full segments that define a route of a length that depends on a designated drive duration in distance or time between two nodes;
fractional segments define a route having a length that is an integer fraction of a full segment;
segments define a route whose length is an integer multiple of a full segment, or an integer multiple of a fractional segment;
a convoy configuration is an assignment of a) tractors to trailers and/or b) drivers to tractors and/or c) a designation of which drivers are in service and/or d) assignment of loads to tractors; and
drivers are assigned to a selected convoy configuration with two drivers assigned to a unit;
a drive duration comprises two or more fractional segments such that
during a first fractional segment a first driver is in service while a second driver rests; and
during a second fractional segment the first driver rests while the second driver is in service.

13. A transportation network comprising:
a plurality of nodes, the nodes including end nodes that serve as locations where a trailer and/or a tractor may enter or leave the network and relay nodes that serve as locations were a configuration change may occur;
a plurality of legs, each leg specifying a unique path between two nodes with no nodes in between the legs optionally constrained to conform to a highway system the legs further organized such that sequences of legs, known as routes, form “full segments” that define a route of a length that depends on a designated drive duration in distance or time between two nodes;
such that fractional segments define a route having a length that is an integer fraction of a full segment;
such that segments define a route whose length is an integer multiple of a full segment, or an integer multiple of a fractional segment;
a convoy configuration comprises an assignment of a) tractors to trailers and/or b) drivers to tractors and/or c) a designation of which drivers are in service and/or d) assignment of load to tractors; and
drivers are assigned to a selected convoy configuration with two drivers assigned to a unit; and
a drive duration comprises two or more fractional segments such that
during a first fractional segment a first driver is in service while a second driver sleeps; and
during a second fractional segment the first driver sleeps while the second driver is in service.

14. The network of claim 13 wherein the selected convoy configuration includes at least two tractors, wherein at least one tractor is driven by autonomy, and wherein the first and second drivers are human drivers.

15. The network of claim 14 wherein both the first driver and second driver are located in a given tractor.

16. The network of claim 14 wherein at least one of the sleeping drivers is located in the autonomy driven tractor.
